(19) United States
(12) Patent Application Publication
(10) Pub. No.: US 2021/0396059 A1
(43) Pub. Date: Dec. 23, 2021

(54) Spring Assisted Overhead Door

(71) Applicant: Hall Labs LLC, Provo, UT (US)

(72) Inventors: David R. Hall, Provo, UT (US); Jerome Miles, Spanish Fork, UT (US)

(73) Assignee: Hall Labs LLC, Provo, UT (US)

(21) Appl. No.: 17/355,112

(22) Filed: Jun. 22, 2021

Related U.S. Application Data
(60) Provisional application No. 63/042,528, filed on Jun. 22, 2020.

(51) Int. Cl. E05F 1/16; E05F 15/686

(52) U.S. Cl. CPC E05F 1/16; E05F 15/686; E05Y 2201/434; E05Y 2900/106; E05Y 2201/654; E05Y 2201/684; E05Y 2201/474

(57) ABSTRACT

A spring assisted overhead door is disclosed. An overhead door is movable between an open and a closed position. In the open position the overhead door is in a horizontal orientation and rests on a track that is also horizontal. Weight of the door in this position may be insufficient to initiate downward movement of the overhead door. A spring is used to urge the overhead door along the track until a release point at which point the overhead door is at least partially on a downwardly oriented portion of the track where gravity can pull the overhead door along the track.

### CROSS-REFERENCE TO RELATED APPLICATIONS

This application claims priority to U.S. Provisional Patent Application No. 63/042,528 entitled “SPRING ASSISTED OVERHEAD DOOR” filed Jun. 22, 2020, which is incorporated herein by reference in its entirety.

### TECHNICAL FIELD

The present disclosure is directed to overhead doors and overhead door openers.

### BACKGROUND

Overhead doors are used in many buildings including residential, industrial, and commercial buildings. They are operated by a motor and equipped with safety equipment such as optical sensors and other devices used to prevent accidents due to the weight of the door and the force of the motor. There have been many safety advancements in recent years. Further safety advancements are desired in the art.

### SUMMARY

Embodiments of the present disclosure are directed to a spring assisted overhead door system including a track comprising a vertical portion at a lower end of the track, a transition portion, and a horizontal portion at an upper end of the track. The transition portion is between the vertical portion and the horizontal portion. The system also includes an overhead door being movable along the track between a closed position and a raised position under power of a motor, and a spring having a first end coupled to a fixed structure that does not move when the overhead door is raised or lowered, and a second end that is free. The second end impedes movement of the overhead door into the raised position whereby the overhead door energizes the spring such that the energized spring urges the overhead door away from the raised position and the motor holds the overhead door against the spring when in the raised position. The spring urges the overhead door away from the raised position until the weight of the overhead door is carried by the motor.

Further embodiments of the present disclosure are directed to a spring having a first end mounted to a stationary structure and a second end. The second end is in the path of an overhead door that runs on a track that has a substantially horizontal portion, a transition portion, and a substantially vertical portion. The overhead door contacts and deflects the second end of the spring when the overhead door is moved into an overhead horizontal position. The spring first contacts the overhead door while the overhead door is at least partially in the transition portion or the vertical portion. The spring urges the overhead door toward a lowered position until the overhead door falls toward the lowered position.

Further embodiments of the present disclosure are directed to an overhead door system that includes a track defining a path of an overhead door between a closed position in which the overhead door is in a substantially vertical orientation and an open position in which the overhead door is in a horizontal position. The system also includes an overhead door movable along the track between the closed and open positions. The system also includes a shaft to which the overhead door is mounted. Rotation of the shaft causes movement of the overhead door along the track. The system also includes a motor operably coupled to the shaft to control rotation of the shaft to raise, lower, or stop movement of the overhead door. The motor has a one-way bearing that allows the motor to apply torque to the shaft in an upward direction to raise the overhead door and to support the weight of the overhead door as it is lowered. The one-way bearing does not allow the motor to apply a torque to the shaft in a downward direction opposite the upward direction. The system also includes a spring in the path of the overhead door. The overhead door energizes the spring as the overhead door reaches the horizontal position. The spring stores sufficient energy to move the door out of the horizontal position and along the path until the weight of the overhead door is carried by the shaft.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative, and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a front view of an overhead door according to embodiments of the present disclosure.

FIG. 2 is a view similar to FIG. 1, showing the overhead door in a lifted state with the spools wound up and the cables wound up to raise the overhead door according to an embodiment of the present disclosure.

FIG. 3 is a view of the motor unit according to an embodiment of the present disclosure.

FIG. 4 is a view similar to FIG. 3, with the cover removed according to an embodiment of the present disclosure.

FIG. 5 shows an overhead door system according to embodiments of the present disclosure in a lowered position.

FIG. 6 shows an overhead door system according to embodiments of the present disclosure in a raised position.

FIG. 7 is a side view of a spring assisted overhead door system according to embodiments of the present disclosure.

FIG. 8 is a schematic view of a spring unit using a compression spring with the door in the closed position.

FIG. 9 is a view similar to FIG. 8 with the door in the open position.

FIG. 10 is a schematic view of a spring unit using a tension spring with the door in the closed position.

FIG. 11 is a view similar to FIG. 8 with the door in the open position.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “spring” is meant to refer to any resilient member that can be pressed or pulled but returns to its former shape when released. Springs can be helical, metal springs, solid elastic members, or plastic members, or any other material suitable for the environment in which it is found. Springs generally have a linear coefficient wherein the force exerted by the spring is linearly proportional to the displacement away from the initial, undeformed shape. Springs can be mounted in tension or compression, or in any other method of deformation. The term “spring” is used herein and springs are depicted in the Figures that may refer to or depict specific types of springs without loss of generality.

As used herein, “door” and “overhead door” are used interchangeably to refer to overhead doors suitable for use with the systems and methods of the present disclosure.

“Vertical” and “horizontal” when applied to a position of an overhead door are understood to mean that the overhead door in in a generally vertical or horizontal position. It is to be understood that portions of the overhead door may not be perfectly vertical or horizontal.

A one-way bearing is any device that is capable of transmitting torque when rotated in one direction but does not transmit torque when rotated in the opposite direction. Many one-way bearings have two pieces that rotate relative to one another when rotated in the direction in which torque is not transmitted, and that do not rotate relative to one another when rotated in the opposite direction. Some examples of a one-way bearing are one-way clutch bearings or Sprag style bearings that are constructed from a drawn cup with needle roller clutches and have a small radial section height. They are often called one-way bearings, anti-reverse bearings and clutch bearings. Preferably, the units are compact, lightweight and operate directly on a shaft; they are also suitable for transmitting high torque.

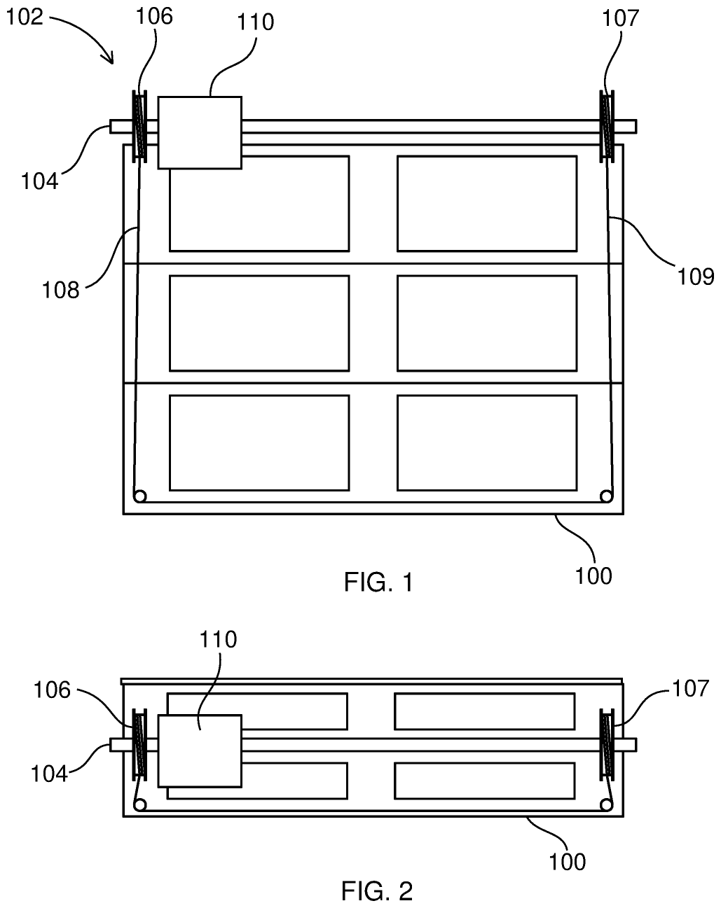

FIG. 1 is a front view of an overhead door 100 according to embodiments of the present disclosure. Many homes have overhead doors that are used to enter a garage. Many residential overhead doors are used for automobiles and are opened via a remote control in the car and in the garage to open and close the overhead door. The overhead door 100 of the present disclosure is coupled to an opener 102 which includes a shaft 104, spools 106 and 107 at either end of the shaft 104, and cables 108 and 109 that connect to the spools and to the overhead door 100. A motor unit 110 is coupled to the shaft 104 and turns the shaft 104 which turns the spools 106, 107 and winds the cables 108, 109 onto and off of the spools 106, 107 to raise and lower the overhead door 100, respectively. In some embodiments the cables are a single cable that extends from one spool 106 to the overhead door 100 and along the lower edge and up to the other spool 107. In other embodiments there can be a single spool on one side of the shaft 104. In still further embodiments the spool is centrally located and the motor unit 110 winds the spool from the center of the overhead door 100.

In some embodiments the motor unit 110 is directly coupled to the shaft 104 to rotate the shaft 104 to operate the overhead door. In other embodiments the motor unit 110 is coupled to a belt drive or other mechanical system used to raise and lower the overhead door 100.

FIG. 2 shows the overhead door 100 in a lifted state with the spools 106, 107 wound up and the cables 108, 109 wound up to raise the overhead door 100. The overhead door 100 can be raised and lowered in response to a signal from a remote or a hard-wired control inside the garage or outside the garage.

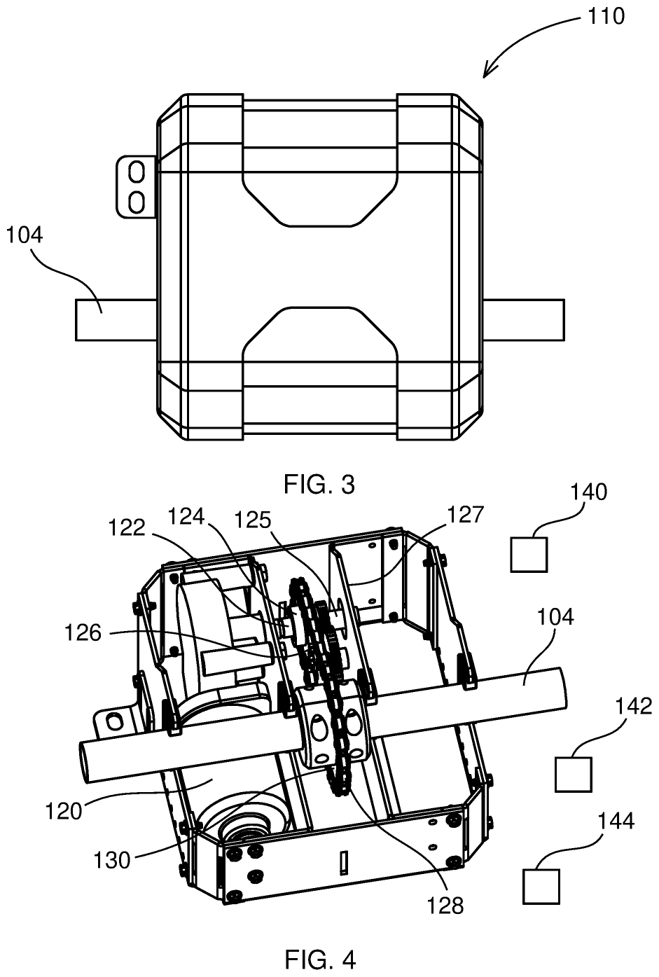

FIG. 3 shows the motor unit 110 according to embodiments of the present disclosure. A portion of the shaft 104 is shown protruding from either side of the motor unit 110. The motor unit 110 can be positioned anywhere on the shaft 104, including outside of the spools shown in FIGS. 1 and 2. The motor unit 110 can be installed onto the shaft after the overhead door and shaft 104 have been installed. In some embodiments, the motor unit 110 can be used to retrofit an existing overhead door without time and labor-intensive disassembly of the overhead door.

FIG. 4 shows the motor unit 100 with a cover removed according to embodiments of the present disclosure. The motor unit 110 includes a motor 120 having an output shaft 122 receiving the mechanical power from the motor 120 to raise and lower the overhead door by turning the shaft 104. The output shaft 122 has a one-way bearing 124 coupled to the output shaft 122 and a sprocket 126 coupled to the one-way bearing 124. A one-way bearing is any device that is capable of transmitting torque when rotated in one direction but does not transmit torque when rotated in the opposite direction. Many one-way bearings have two pieces that rotate relative to one another when rotated in the direction in which torque is not transmitted, and that do not rotate relative to one another when rotated in the opposite direction. Some examples of a one-way bearing are one-way clutch bearings or Sprag style bearings that are constructed from a drawn cup with needle roller clutches and have a small radial section height. They are often called one-way bearings, anti-reverse bearings and clutch bearings. The units are compact, lightweight and operate directly on a shaft; they are also suitable for transmitting high torque.

A chain 128 is coupled to the sprocket 126. The shaft 104 is shown carrying a sprocket 130 that engages with the chain 128. Mechanical power is therefore transmitted from the motor 120, to the one-way bearing 124, through the sprocket 126, the chain 128, and delivered to the sprocket 130 which turns the shaft 104 to raise and lower the overhead door. In some embodiments the chain 128 can be replaced by any suitable mechanical equivalent, such as meshing gears, a belt, or any other suitable mechanical equivalent capable of delivering torque and power to the shaft 104.

The one-way bearing 124 is designed to transmit torque when the motor turns in a first direction that causes the overhead door to raise. The one-way bearing 124 also transmits torque in the first direction when the motor 120 is operated in reverse to lower the overhead door. The weight of the door on the bearing creates the torque in the first direction as the door is raised and lowered. The “first direction” is an angular direction when referring to the torque applied by the one-way bearing 124. Movement in a second direction opposite the first direction, however, causes the one-way bearing 124 to rotate freely. The one-way bearing 124 can be made of two separate parts, one coupled to the output shaft 122 and one coupled to the sprocket 126. These parts are not allowed to rotate relative to one another in the first direction but are allowed to rotate relative to one another in the second direction. Accordingly, the motor 120 cannot transmit torque in the second direction to the overhead door. The motor 120 can transmit torque to the shaft 104, but the shaft 104 cannot transmit torque to the motor 120. Of course, no bearing is completely devoid of torque. There may be some resistance and friction, but the overall effect is as close to zero transmitted torque as is practically possible. When the overhead door is lowered and contacts an impediment that stops downward movement of the overhead door, it will cause a torque to be applied through the door and into the shaft 104. The one-way bearing 124 will not transmit this torque and will also therefore prevent the motor 120 from exerting a downward force on the door. The only downward force then is the weight of the door itself, which can be balanced by a spring as is known in the art. The one-way bearing 124 is therefore a safety mechanism that does not require any power to operate.

When the door is in a fully or mostly retracted position, most of the weight of the door is supported by components such as upper rails (not shown) above the shaft 104 and therefore the weight is not acting on the shaft 104. If there is insufficient weight on the shaft 104 to cause the shaft 104 to rotate and lower the door, the motor 120 needs to apply downward torque to the shaft 104. However, the one-way bearing 124 prevents such torque in part to prevent downward torque from causing an injury. To address this, an electro-mechanical clutch 125 may be coupled to the one-way bearing 124. The electro-mechanical clutch 125, when activated, fixes the one-way bearing and fixes the one-way bearing, effectively converting the one-way bearing 124 into a rigid coupling fastened to the shaft 104 that is capable of transmitting torque in both directions. When the electro-mechanical clutch 125 is not activated, the one-way bearing 124 operates as a one-way bearing.

The electro-mechanical clutch 125 can be configured to operate for a first distance of travel of the door. For example, the first two feet of movement is in some embodiments sufficient distance for the weight of the door to provide the downward force to close the door. In other embodiments a tension monitor 127 can be used to monitor the tension on the electro-mechanical clutch 127 and if the tension reaches a certain level it will release the one-way bearing 124. The electro-mechanical clutch 125 can be operated with power from a power supply (not shown) to the motor or from the motor or from another outlet in the garage. The electro-mechanical clutch 125 can be configured to fail open, meaning that in the event of power loss the electro-mechanical clutch 125 does not grasp the one-way bearing, permitting the door to be opened manually, and not to exert a downward force onto the door.

As a result, any blockage of the downward movement of the door will cause the one-way bearing 124 to spin. The spools (refer to FIGS. 1 and 2) will immediately stop spinning, and even though the motor 120 may continue to rotate, the spools will not continue to rotate and create slack in the cables. Also, the downward force of the door is limited to the weight of the door. In most embodiments, this weight is counterbalanced by a torsion spring on the shaft to further reduce the weight of the door as it moves upward and downward. The torsion spring is connected at one end to the shaft and at the other end to a stationary piece on the structure. The overhead door of the present disclosure is therefore safer and less prone to errors than conventional designs that require sensors and other electronic mechanisms such as force limiters and other similar devices to stop a downward force from causing damage to the source of the perhaps delicate item or person blocking the door. The stoppage of the downward force of the door is not subject to an electronic system working properly. The one-way bearing 124 requires no electronics, no communication, and no software to prevent a dangerous situation from harming someone who finds themselves under the door as it comes down.

The motor unit 110 can also include a monitor 140 operably coupled to the output shaft 122. The monitor 140 observes a velocity of the output shaft 122. The motor unit 110 can also include a second monitor 142 operably coupled to a component of the drive train, including any one or more of the chain 128, the sprocket 126, the sprocket 130, or the shaft 104. Even the portion of the one-way bearing 124 that is coupled to the sprocket 126 and does not necessarily rotate the same as the output shaft 122 of the motor can be monitored by the second monitor 142. Any component downstream from the one-way bearing 124 can be monitored by the second monitor 142. The second encoder 142 can be configured to monitor position and velocity and from these measurements, a position and velocity of the door itself can be calculated.

In some embodiments the monitors 140, 142 can be an encoder such as a rotary encoder, also called a shaft encoder. An encoder is an electro-mechanical device that converts the angular position or motion of a shaft or axle to analog or digital output signals. There are two main types of rotary encoder: absolute and incremental. The output of an absolute encoder indicates the current shaft position, making it an angle transducer. The output of an incremental encoder provides information about the motion of the shaft, which typically is processed elsewhere into information such as position, speed and distance. Rotary encoders are used in a wide range of applications that require monitoring or control, or both, of mechanical systems, including industrial controls, robotics, photographic lenses, computer input devices such as optomechanical mice and trackballs, controlled stress rheometers, and rotating radar platforms.

The first monitor 140 and second monitor 142 operate together to monitor slippage of the one-way bearing 124. When the torque is applied in the first direction, the two components of the one-way bearing 124 will not rotate relative to one another, but when the overhead door is stopped from moving downward, the one-way bearing rotates and this rotation difference will be measurable by the second monitor 142. A controller 144 can be coupled to the monitors and to the motor 120 and can operate to stop the motor 120 if the rotation deviates from the expected values by more than a predetermined quantity. The controller 144 can issue any of a series of commands in response to such rotational deviancy. The commands can include stopping the motor, issuing an alarm, retracting the door to a known “safe” place, recalibrating the door position, and issuing a notification to a mobile phone or a smart home system, etc.

The monitors 140, 142 and controller 144 are shown schematically. It is to be appreciated by a person of ordinary skill in the art that these components can be built into the motor 120, they can be wireless and/or remote, they can be attached to the shafts and components of the motor unit 110. It is understood how the monitors and controllers operate even without a detailed depiction.

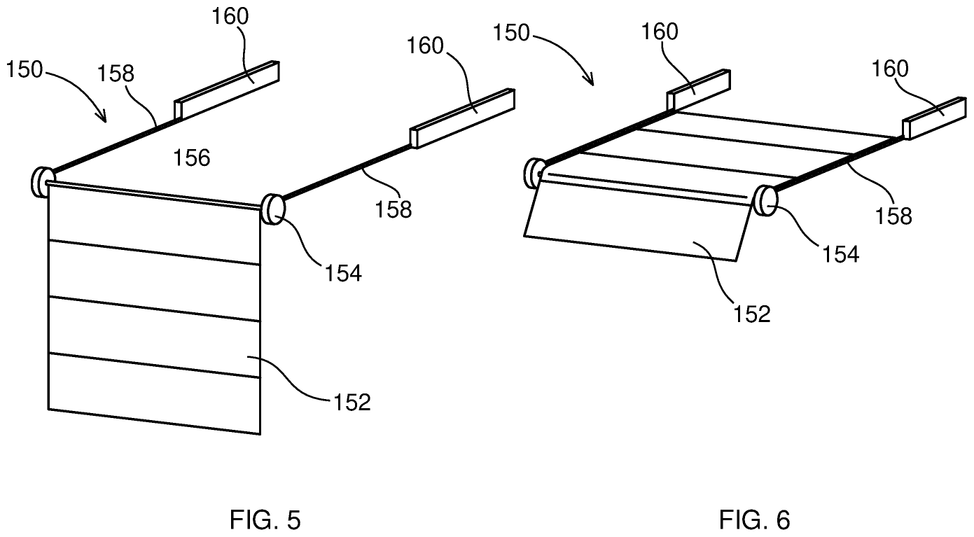

FIGS. 5 and 6 show an overhead door system 150 according to embodiments of the present disclosure in lowered and raised positions, respectively. The overhead door system 150 includes an overhead door 152, spools 154, and a shaft 156. The system 150 also includes rails 158 that guide the overhead door as it moves along a path overhead as the door 152 is raised. The system 150 also includes a spring 160 at a rearward portion of the rails 158. As the overhead door 152 is raised it moves along the rails and moves rearward and imparts energy into the spring 160. The spring 160 may be a spring, a gas compressor, or any other suitable form of storing energy as provided by the overhead door 152 as it is raised and moves along the rails 158. In FIG. 6 the spring device 160 is compressed. In some embodiments the spring 160 can be toward the front of the door and can be extended by moving the overhead door 152 rearwardly.

FIG. 6 shows the door in a partially lowered state in which one panel 180a of the door 152 has begun the descent. The spring 160 can be sufficiently long and stiff so as to push the door 152 far enough down the rails 158 that the weight of the door is carried by the shaft and the one-way bearing. The spring 160 therefore helps to initiate the downward motion of the door 152 which from a horizontal position as shown in FIG. 5 may not be able to push downward due to the one-way bearing, and the fact that the weight of the door is supported by the rails 158 in a horizontal orientation. The point at which the door 152 has moved downward far enough that the weight of the door 152 is carried by the shaft may be different for different doors and different installations.

FIG. 7 is a side view of a spring assisted overhead door system 152 according to embodiments of the present disclosure. The system 152 includes an overhead door 180 and an overhead door opener 182 that is mounted to a shaft 184 to raise and lower the overhead door 180 using a spool 186 and a cable 188 as shown and described above. The opener 182 raises and lowers the door 180 along the rails 158 that define a path for the door 180 to move between a closed position and an open position with the door 180 overhead. The rails 158 define a track for the overhead door. The rails 158 can have a vertical portion 110, a curved portion 112, and a horizontal portion 114. The curved track portion 112 may be a series of angled sections and may be referred to herein as the transitional portion 112 because it transitions between the vertical portion 110 and the horizontal portion 114. The door 180 shown here is a sectional door having panels 190a-190c (collectively referred to herein as panels 190). The panels 190 are hinged horizontally relative to one another so the overhead door can negotiate the curved track portion 112 as it is raised and lowered. The panels 190 can have rollers that engage with the track 102. The system 100 can be used with other types of overhead doors and other types of tracks that may interface the track and door differently.

One such type of door opener is disclosed in detail in U.S. patent application Ser. No. 16/805,771 entitled MECHANISM FOR OPENING AND CLOSING AN OVERHEAD DOOR INCLUDING ONE WAY BEARING which is incorporated herein by reference in its entirety. The opener 182 can have a one-way bearing to prevent the motor from exerting a downward force on the overhead door. One possible problem with such a system, that may exist with different openers as well, is that while the door 101 is in the fully raised position, initiating the downward movement is difficult. The horizontal portion 114 of the track is horizontal, so the door will rest on the track 102 and will not move downward.

The system 100 includes a spring 200 mounted to an end 192 of the rails 158. In some embodiments the spring 200 is mounted to a far end of the horizontal portion 114 of the rails 158. In other embodiments the spring 200 can be mounted to a wall or to the ceiling or other support structure sufficiently rigid and secure to provide an anchor point for the spring 200. A first end 202 of the spring 200 is affixed to the wall or other secure structure. A second end 204 opposite the first end contacts the overhead door 180 and urges it away from the raised position. The spring 200 may be configured to contact the overhead door 180 without any latch mechanism to hold the second end 204 to the overhead door 180. When the overhead door 180 moves away from the raised position by a predetermined distance, the spring 200 releases. From then on, the overhead door 180 is supported by the shaft 184 via the cable 188. The opener 182 allows this downward motion by rotating the shaft 184 which extends the cable 188. The overhead door 180 is therefore moved to the closed position.

The overhead door 180 is shown in a partially descended position with the lowest panel 190a beginning to travel along the curved portion 112 of the rails 158. The spring 200 urges the door 180 along the rails 158 a sufficient distance that the weight of the door 180 is supported by the opener 182 via the cable 188 and the shaft 184. The length of the spring 200 depends on dimensions of the overhead door 101 and the structure of the overall system 100. In some embodiments, the length is determined by the weight of the overhead door 180 as a function of how the overhead door 180 operates. In some embodiments the length is sufficiently long to allow the overhead door 101 to travel along the track 102 down far enough that gravity takes over and the weight of the overhead door 180 is supported by the cable 188 and shaft 184. In some embodiments the lower edge of panel 190a is pushed down two feet as measured vertically from the horizontal portion 114 of the rails 158.

In another aspect, the overhead door 180 has a release point defined as a point at which the weight of the overhead door 180 has moved sufficiently along the track along the curved portion 112 and downward that there is enough weight pulling downward on the overhead door 180 that it will continue downward along the track if it were left alone. The opener 182 may be able to exert an upward force on the door, but not a downward force. The opener 182 can include a one-way bearing structure that prevent it from exerting any downward force on the door for safety reasons, but without the ability to exert a downward force, the opener 182 may be unable to initiate downward movement from a purely horizontal position since all the weight is resting on the horizontal portion 114 of the rails 158. The release point may vary depending on the weight of the overhead door 180, the characteristics of the rails 158 in terms of friction or other impediments.

The spring 200 may be mounted as shown in FIG. 7 to be loaded in compression when the overhead door 180 is raised. In other embodiments the spring 200 may be mounted to the overhead door directly. It may be mounted to extend in tension when the overhead door 180 is raised. In still other embodiments the spring 200 can be mounted to the ceiling and can be deflected to bend the spring 200.

The spring 200 has a neutral position where it rests when not displaced by the overhead door. When the spring 200 reaches this position it can no longer urge the overhead door 180 downward. In some embodiments the neutral position is beyond the release point. In other words, there are three stages along the track where the spring 200 and gravity act on the overhead door 180. In the first stage the overhead door 180 is in the raised, horizontal position in which gravity is insufficient to pull the overhead door 180 downward. In this stage the spring 200 is deformed and is storing energy that urges the overhead door 180. This stage includes the first movement of the overhead door 180 downward as the motor allows the overhead door 180 to move downward.

The second stage begins when the overhead door 180 reaches the release point and gravity is sufficient to pull the overhead door 180 downward. The door 180 would continue downward without input from the motor or the spring if allowed to do so. In some embodiments, the spring 200 still contacts the overhead door 180 during the second stage. The second stage is an overlapping stage where gravity is sufficient to pull the door downward and the motor is supporting the weight of the overhead door 180 as it allows the overhead door 180 to move downward, and also the spring 200 exerts a force on the overhead door 180 to urge it downward. The spring 200 has not yet reached the neutral position. The second stage may be relatively short, but so long as there is an overlap the overhead door 180 will not be in a position where gravity is insufficient to move it and the spring 200 has released.

The third stage is after the overhead door 180 has moved beyond the release point and the spring 200 has reached the neutral position. At this point the motor supports the weight of the door and continues to allow gravity to move the door downward until it reaches the closed, vertical position.

The spring 200 can be relatively long and can have a relatively low spring coefficient such that the spring 200 urges the overhead door during approximately half the length of the horizontal portion 114 of the track, and the force of the spring is relatively low. The spring 200 needs only to have enough strength to move the relatively light overhead door 180 along a track designed to conduct the overhead door 101. The spring 200 gives a nudge to begin the movement and does not constitute a large force.

The opener 182 has sufficient power to overcome the spring 200 to compress the spring 200 as the door moves toward and into the raised position. When the door 180 is in the raised position, it will be held in an energized state between the opener 182 and the spring 200. Many garage door operators have a release mechanism that can release the door from the operator for convenience during a power outage for example. The system of the present disclosure can include such a release system that can be configured to release the opener 182 from the door 101, and simultaneously release the spring 200 so the spring 200 does not move the door forward and downward. In some embodiments the release mechanism releases the spring 200 before releasing the operator 104. In some embodiments the release mechanism is two separate release mechanisms, the first releases the spring 200 and the second releases the operator 104. In some embodiments the release mechanism is two-part with a single actuator, such as a lever or cable which is pulled in one movement. The first portion of the movement releases the spring 200 and the second portion releases the door 101. To the operator the action is unnoticeable—one movement releases the door, and the spring 200 does not eject the door 101 downward.

To initiate a downward movement of the door 180, the opener 182 is actuated by a remote signal or by a button press to move the door 180. The opener 182 begins to rotate the shaft 184 to release the cable 188 to lower the door 180. The spring 200 is passive and urges the door 180 toward the lowered position. The spring 200 will continue to urge the door 180 downward until the predetermined distance is reached, at which point the door 180 is released from the spring 200 and the door 180 continues its downward movement. In some embodiments the spring 200 merely abuts the door 180 or some portion of the door or a tab or protrusion on the door and does not latch to the door 180. The spring 200 can be a helical spring or any other suitable biasing member capable of behaving as described herein. In some embodiments the spring 200 may be mounted in front of the door 101 and operates in tension and not compression.

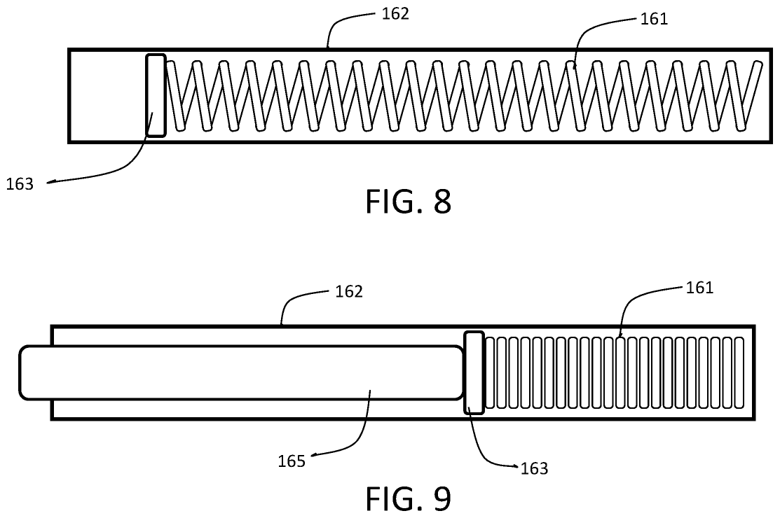

FIGS. 8 and 9 illustrate an embodiment using a compression spring. The compression spring 161 is held within housing 162. As seen in FIG. 8, the spring 161 is at rest in its extended state when the overhead door is in the closed position. As the door is opened to a certain point, a feature of the overhead door 165, such as a tab, bracket or other feature which is either attached to or integral with the door, contacts the contact surface 163 of the spring and begins to compress the spring 161 as the overhead door continues to open. As the overhead door is fully opened, as illustrated in FIG. 9, the spring 161 is fully compressed. As such, the spring has stored energy ready to assist the closing of the overhead door.

Preferably, a housing with a compression spring is included on both side of the overhead door. Alternatively, a single housing and compression spring are located near the center of the overhead door.

Although a helical coil compression spring 161 is shown for this embodiment, other types of compression springs are used in other embodiments. For example, the compression spring may be a compressible material, such as an open cell foam member, or a compressible gas cylinder (air spring).

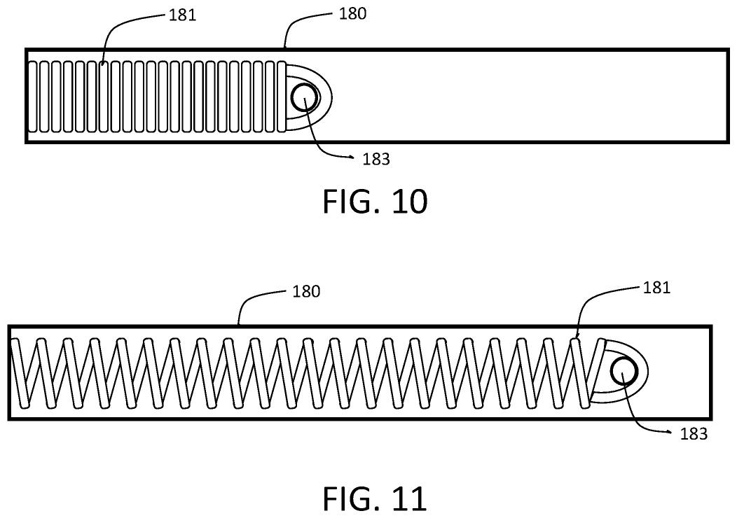

FIGS. 10 and 11 illustrate an embodiment using a tension spring. The tension spring 181 is held in housing 182. As seen in FIG. 10, the spring 181 is at rest in its non-extended state when the overhead door is in the closed position. As the door is opened to a certain point, a feature of the overhead door contacts the catch 183 and begins to extend the spring 181 as the door continues to open. As illustrated in FIG. 11, when the door is fully opened, the spring 181 is fully stretched, thus storing energy that is used to assist closing the overhead door.

Preferably, a housing with a compression spring is included on both side of the overhead door. Alternatively, a single housing and tension spring are located near the center of the overhead door.

Although a helical coil tension spring is shown in these Figures, other embodiments use other types of tension springs. For example, the tension spring may be formed from an elastic material, such as rubber, that is stretched as the door is fully opened. The tension spring may also be an air spring, i.e. formed with a pneumatic cylinder.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A spring assisted overhead door system, comprising:
a track comprising a vertical portion at a lower end of the track, a transition portion, and a horizontal portion at an upper end of the track, the transition portion being between the vertical portion and the horizontal portion;
an overhead door movable along the track between a closed position and a raised position under power of a motor; and
a spring having a first end coupled to a fixed structure that does not move when the overhead door is raised or lowered, and a second end that is free;
wherein the second end impedes movement of the overhead door into the raised position, whereby the overhead door energizes the spring as the overhead door moves toward the raised position such that the energized spring urges the overhead door away from the raised position and the motor holds the overhead door against the spring when in the raised position; and
wherein the spring urges the overhead door away from the raised position until the weight of the overhead door is carried by the motor.

2. The spring assisted overhead door system of claim 1 wherein the transition portion is curved.

3. The spring assisted overhead door system of claim 1 wherein the first end of the spring is parallel to the horizontal portion of the track.

4. The spring assisted overhead door system of claim 1 wherein the release point is when the overhead door has moved along the track in a downward direction by at least two feet.

5. The spring assisted overhead door system of claim 1 wherein the track defines a three-stage path, wherein:
in the first stage the spring contacts the overhead door and urges the overhead door toward the closed position along the track and wherein gravity is insufficient to advance the overhead door;
in the second stage the spring continues to contact the overhead door and urge the overhead door toward the closed position along the track, and wherein gravity is sufficient to advance the overhead door;
in the third stage the spring no longer contacts the overhead door and gravity is sufficient to advance the overhead door, and wherein the motor supports the weight of the overhead door; and wherein
moving from the raised position the overhead door moves from the first stage to the second stage to the third stage.

6. The spring assisted overhead door system of claim 1 wherein the motor comprises a one-way bearing configured to support the weight of the overhead door to rise and lower the overhead door, wherein the one-way bearing is incapable of exerting a downward force on the overhead door.

7. The spring assisted overhead door system of claim 1, further comprising a release mechanism configured to release the overhead door from the motor and the spring.

8. The spring assisted overhead door system of claim 7 wherein the release mechanism releases the spring from the overhead door before releasing the overhead door from the motor.

9. The spring assisted overhead door system of claim 7 wherein the release mechanism has a single movement manually actuated that first releases the spring from the overhead door and second releases the motor from the overhead door.

10. A spring for an overhead door having a first end mounted to a stationary structure and a second end, wherein the second end is in the path of an overhead door, the overhead door running on a track that has a horizontal portion, a transition portion, and a vertical portion;
wherein the overhead door contacts and deflects the second end of the spring when the overhead door is moved into an overhead horizontal position;
wherein the spring first contacts the overhead door while the overhead door is at least partially in the transitional portion or the vertical portion; and
wherein the spring urges the overhead door toward a lowered position until the overhead door falls toward the lowered position.

11. The spring system of claim 10 wherein the first end of the spring is mounted to the track.

12. The spring of claim 10 wherein the spring is compressed linearly by the overhead door as the overhead door moves along the track toward the overhead horizontal position.

13. The spring of claim 10 wherein the overhead door further comprises a motor configured to raise and lower the overhead door, wherein the motor comprises a one-way bearing that is configured to exert an upward force on the door to raise and to lower the door and is configured to prevent the motor from exerting a downward force on the door, wherein the spring urges the overhead door toward the lowered position until the overhead door falls toward the lowered position.

14. An overhead door system, comprising:
an overhead door movable along the track between a closed position, in which the overhead door is in a vertical orientation, and an open position, in which the overhead door is in a horizontal position;
a track defining a path of the overhead door between the closed position and the open position;
a shaft to which the overhead door is mounted, wherein rotation of the shaft causes movement of the overhead door along the track;
a motor operably coupled to the shaft to control rotation of the shaft to raise, lower, or stop movement of the overhead door, the motor having a one-way bearing that allows the motor to apply torque to the shaft in an upward direction to raise the overhead door and to support the weight of the overhead door as it is lowered, wherein the one-way bearing does not allow the motor to apply a torque to the shaft in a downward direction opposite the upward direction; and
a spring in the path of the overhead door, wherein the overhead door energizes the spring as the overhead door reaches the horizontal position, wherein the spring stores sufficient energy to move the door out of the horizontal position and along the path until the weight of the overhead door is carried by the shaft.

15. The overhead door system of claim 14 wherein the track has a horizontal portion, a transition portion curved downwards, and a vertical portion, wherein the weight of the overhead door is carried by the shaft when the overhead door reaches the transition portion.

16. The overhead door system of claim 15 wherein the weight of the overhead door is carried by the shaft once the overhead door passes the transition portion.

17. The overhead door system of claim 14 wherein the weight of the overhead door is carried by the shaft once the overhead door has travelled downward by at least two feet.

18. The overhead door system of claim 15 wherein the track comprises two parallel tracks and wherein the spring comprises two helical springs aligned with the track at the horizontal portion of the track.

19. The overhead door system of claim 15 wherein the spring at rest is approximately half as long as the horizontal portion of the track.

20. The overhead door system of claim 14 wherein the spring contacts but does not latch onto the overhead door.
